(19) United States
(12) Patent Application Publication
(10) Pub. No.: US 2004/0085474 A1
(43) Pub. Date: May 6, 2004

(54) Sensor module

(76) Inventors: Michael Trunz, Ellwangen-Pfuhlheim (DE); Alexander Hinz, Koenigsbronn (DE)

Correspondence Address: HOLLAND & KNIGHT, LLP, ONE EAST BROWARD BLVD., SUITE 1300, FT LAUDERDALE, FL, 33301

(21) Appl. No.: 10/645,164

(22) Filed: Aug. 21, 2003

(30) Foreign Application Priority Data
Aug. 23, 2002 (DE) 102 39 524.1

(51) Int. Cl. H04N 5/225

(52) U.S. Cl. 348/340

(57) ABSTRACT

A sensor module has a CCD sensor unit 4, arranged in a housing 2. A plate-like carrier unit 6, which bears the CCD sensor unit 4, is provided between a housing surface 8 and the CCD sensor unit.

### PRIORITY CLAIM

Priority is hereby claimed under 35 U.S.C. §119 to German patent application serial number 102 39 524.1 filed on Aug. 23, 2002.

### FIELD OF THE INVENTION

The invention relates to the field of photography. More particularly, the invention relates to a sensor module of the type having a CCD sensor unit which is arranged in a housing.

### BACKGROUND OF THE INVENTION

A sensor module of the above type is known from DE 100 57 647 A1, which describes a sensor module having a CCD sensor unit which is designed as a CCD chip and is arranged in a housing. The housing is closed off by a glass plate on a side which faces toward the light-sensitive region of the CCD sensor unit. The CCD sensor unit is arranged directly on a housing surface at the base of the housing.

Philips markets, as FTF 3020-M, a full frame CCD image sensor having a sensor module which comprises a CCD chip made from single-crystalline silicon. This CCD chip is adhesively bonded to the base of a ceramic housing. The ceramic housing is hermetically sealed using a sealing glass of optical quality. Electrical terminal contacts are formed on the ceramic housing. These terminal contacts are connected to corresponding contact regions on the CCD chip via thin gold wires.

### SUMMARY OF THE INVENTION

Accordingly, it is an object of the invention to provide an electro-optical sensor for a metrological camera which ensures image errors of less than 1 μm even under the operating conditions of an aerial picture camera over a temperature range of −40° C. to +70° C. and a pressure range from approx. 1000 mbar to 300 mbar.

A preferred embodiment of a sensor module according to the invention has a CCD sensor unit, arranged in a housing, with a plate-like carrier unit, which bears said CCD sensor unit, being provided between a housing surface and said CCD sensor unit. This ensures that mechanical stresses of the housing are not transmitted to the CCD sensor unit, so that temperature and pressure fluctuations do not cause any changes in the geometry of the light-sensitive area of the CCD sensor unit and as a result there is also no change in the position of CCD pixels.

According to an aspect of the invention, the thermal expansion of the plate-like carrier unit corresponds substantially to the thermal expansion of the CCD sensor unit. This creates a sensor module in which no image errors occur over a wide temperature range.

According to another aspect of the invention, the plate-like carrier unit may comprise aluminum nitride (AlN), This results in a mechanically stable carrier unit, a thermal expansion of which is, substantially matched to that of the CCD chip.

According to another aspect of the invention, the plate-like carrier unit can be fixed to a housing surface by means of a quasi-punctiform connecting region. In this context, a quasi-punctiform connecting region is understood as meaning that its surface area is significantly smaller than that of the plate-like carrier unit. This allows housing and carrier unit to be effectively mechanically decoupled from one another, so that an expansion or contraction of the housing does not cause any mechanical stresses in the carrier unit.

According to another aspect of the invention, the carrier unit can be fixed to the housing by means of an adhesively bonded joint or soldered joint. This results in a small spacing being formed between housing and carrier unit, while at the same time a mechanical connection is created between these two units, allowing a good heat flux between carrier unit and housing and, furthermore, also providing a solution which is suitable for a mass production process.

According to another aspect of the invention, the CCD sensor unit can be fixed to the carrier unit by means of an adhesively bonded joint. In this way, the CCD sensor unit can be fixed to the carrier unit without mechanical stresses occurring.

According to another aspect of the invention, the housing may include a glass plate. In this way, the CCD sensor unit can be protected from harmful environmental influences.

According to another aspect of the invention, the glass plate may hermetically seal the housing. In this way, it is possible to as far as possible eliminate aging phenomena in the CCD sensor unit, for example oxidation of its surface.

According to another aspect of the invention, the expansion coefficients of glass plate and housing differ by less than 5×10⁻⁶.K⁻¹. In this way, it is possible to reduce mechanical stresses which occur at the housing as a result of temperature fluctuations.

According to yet another aspect of the invention, the housing is designed as a PGA (pin grid array) housing. This results in a sensor module which is easy to exchange.

According to still another aspect of the invention, the housing may be formed, in part, or entirely of Al₂O₃. This results in a robust housing.

A camera having a sensor module according to the invention allows highly accurate aerial pictures to be taken even using light aircraft, without a pressurized cabin or a device for thermally stabilizing the camera.

A preferred embodiment of the invention is illustrated in the drawings and is described below.

### BRIEF DESCRIPTION OF THE DRAWINGS

FIG. 1 shows a perspective view of a preferred embodiment of a sensor module according to the invention; and

FIG. 2 shows a sectional view of the sensor module of FIG. 1 taken along line II-II from FIG. 1.

### DETAILED DESCRIPTION OF A PREFERRED EMBODIMENT

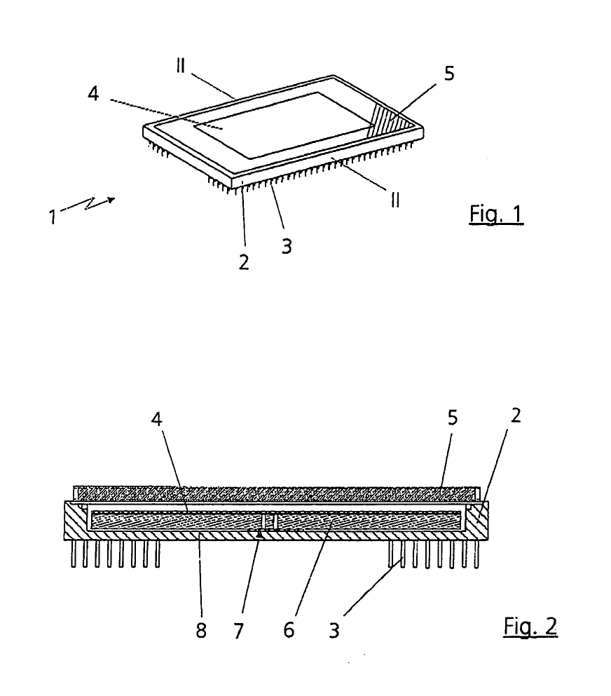

In a preferred embodiment, an image sensor module 1 as shown in FIG. 1 comprises a PGA (pin grid array), housing 2 which is composed of Al₂O₃. Contact feet 3 are formed on the housing, so that the sensor module is suitable for use in a camera, for example an aerial picture camera, and can be readily exchanged in this application. The contact feet 3 are connected to terminals at the CCD sensor unit 4 via bonding wires, not shown in more detail. The CCD sensor unit 4 is held as a crystalline silicon chip, the light-sensitive surface of which covers approximately 40 cm². Preferably, the CCD sensor unit 4 is hermetically sealed in the housing 2 by means of a glass plate 5 of optical quality.

In FIG. 2, assemblies which correspond to those shown in FIG. 1 are provided with the same reference symbols as in FIG. 1.

The CCD sensor unit 4 is adhesively bonded to a plate-like carrier unit 6 which consists of aluminum nitride (AlN). As a result, thermal expansion of the carrier unit 6 is matched to that of the CCD sensor unit 4. The lateral sizes of CCD sensor unit 4 and of carrier unit 6 correspond to one another. However, in the housing 2 there are clearances between the glass plate 5 and the CCD sensor unit 4 and between the wall of the housing 2 and the carrier unit 6 with the CCD sensor unit 4.

The carrier unit 6 itself, together with the CCD sensor unit 4 is fixed centrally to a base surface 8 of the housing 2 by means of an adhesively bonded joint 7, the diameter of which, at approximately 30 to 35 mm, is significantly smaller than the dimensions of the carrier unit 6 and the base surface 8 of the housing. Therefore, this form of connection is referred to as being quasi-punctiform. It should be noted that in principle a soldered joint can also be used instead of an adhesively bonded joint to connect carrier unit 6 and base surface 8 of the housing.

The quasi-punctiform adhesively bonded joint 7 between carrier unit 6 and base surface 8 ensures that there is a narrow spacer gap between carrier unit 6 and base surface 8. The result of this is that even in the event of temperature fluctuations and at high, variable external pressures and a thermal expansion or movement of the walls of the housing 2, with the glass plate 5 at high, variable external pressures, the carrier unit 6 with the CCD sensor unit 4 is held in a stable position. In addition, the mechanical connection of carrier unit 6 and base surface 8 allows a good heat flux between carrier unit 6 and housing 2.

This form of assembly for the CCD sensor unit 4 also ensures that the light-sensitive surface of the CCD sensor unit 4 is not exposed to any mechanical stresses and is always planar even in the event of varying environmental influences.

To maximize the ability of the housing 2 to withstand thermal loads, the glass plate 5 and the material of the walls of the housing 2 are matched to one another in such a way that their coefficients of thermal expansion differ by less than 5×10⁻⁶K⁻¹. To protect the CCD sensor unit 4 from dirt and corrosion, the housing 2 is hermetically sealed by the glass plate 5. It is preferable for the housing to be filled with dry nitrogen before it is hermetically sealed. However, on account of this hermetic seal, fluctuations in the external pressure at the sensor module 1 mean that the latter acts as a pressure casing, the geometry of which is deformed as a function of air pressure. This leads to corresponding bending of wall and glass plate. However, the punctiform adhesively bonded joint 7 between the base of the surface 8 of the housing 2 and the carrier unit 6 made from aluminum nitride ensures that measurable changes in the body of the housing 6 are not transmitted to the geometry of the light-sensitive area of the CCD sensor unit.

What is claimed is:

1. A sensor module, comprising:
(a) a housing having at least one interior wall surface;
(b) a CCD sensor unit disposed at least partially within said housing, and
(c) a plate-like carrier unit disposed between said wall surface and said sensor unit.

2. A sensor module as claimed in claim 1, wherein said plate-like carrier unit has a thermal expansion coefficient which substantially equals the thermal expansion of said CCD sensor unit.

3. A sensor module as claimed in claim 1, wherein said plate-like carrier unit is formed, at least in part, of aluminum nitride (AlN).

4. A sensor module as claimed in claim 3, wherein said plate-like carrier unit is fixed to said housing by means of a quasi-punctiform connection.

5. A sensor module as claimed in claim 1, wherein said carrier unit is fixed to said housing by at least one of, an adhesively bonded joint, and a soldered joint.

6. A sensor module as claimed in one of claim 1, further comprising a gap formed between said carrier unit and said housing.

7. A sensor module as claimed in claim 1, wherein said CCD sensor unit is fixed to said carrier unit by at least one of, an adhesively bonded joint, and a soldered joint.

8. A sensor module as claimed in claim 1, wherein said housing further includes a glass plate.

9. A sensor module as claimed in claim 8, wherein said glass plate hermetically seals the interior of said housing.

10. A sensor module as claimed in claim 8, wherein the respective coefficients of thermal expansion of said glass plate and said housing differ by less than 5×10⁻⁶.K⁻¹.

11. A sensor module as claimed in claim 1, wherein the housing comprises a PGA housing.

12. A sensor module as claimed in claim 1, wherein at least a portion of said housing is formed of Al₂O₃.
